(19) United States
(12) Patent Application Publication
(10) Pub. No.: US 2008/0283311 A1
(43) Pub. Date: Nov. 20, 2008

(54) Balanced ball vehicle

(76) Inventor: Tianfu Li, Troy, MI (US)

Correspondence Address: TIANFU LI, 1103 Winthrop Dr., Troy, MI, 48083, US

(21) Appl. No.: 11/708,882

(22) Filed: Feb. 21, 2007

Related U.S. Application Data
(60) Provisional application No. 60/776,059, filed on Feb. 24, 2006.

(51) Int. Cl. B60K 1/00

(52) U.S. Cl. 180/65.1; 903/902

(57) ABSTRACT

A balancing ball vehicle includes a spherical ball having a center and a central axis that passes through the center, a first driving wheel frictionally engaged with the ball and rotating about a first wheel axis, and a second driving wheel angularly spaced about the central axis from the first driving wheel, frictionally engaged with the ball, and rotating about a second wheel axis.

### REFERENCE TO RELATED APPLICATION

This application claims the benefit of prior-filed Provisional Application No. 60/776,059, filed Feb. 24, 2006.

### BACKGROUND OF THE INVENTION

### Field of the Invention

The preferred embodiment relates generally to an apparatus for supporting and transporting a person on a rotating member, whose direction of transport is determined in response to user input and whose stability is controlled automatically.

### SUMMARY OF THE INVENTION

A balancing ball vehicle is directed by the operator in any desired direction by tilting the vehicle in the desired direction. The vehicle is supported on a spherical ball and is equipped with an electric power source, such as an electric storage battery pack, DC motors frictionally engaged with the ball, and a control system that maintains vehicle stability and drives the vehicle in the desired direction by producing command signals to the drive motors.

The controller repetitively executes control algorithms which employ the magnitude of vehicle tilt and vehicle motion along perpendicular axes to produce the command signals, to which the drive motors respond. Drive wheels contacting the ball drive the ball in the direction that the platform is tilting. The ball is driven such that the vehicle remains balanced.

A balancing ball vehicle includes a spherical ball having a center and a central axis that passes through the center, a first driving wheel frictionally engaged with the ball and rotating about a first wheel axis, and a second driving wheel angularly spaced about the central axis from the first driving wheel, frictionally engaged with the ball, and rotating about a second wheel axis.

In one embodiment, the housing of the drive motors rotate and is driveably engaged frictionally with the outer surface of the ball. These motors require no driving wheels. A gear box, incorporated integrally in the motor assembly, produces a gear ratio between the motor and the rotating housing that drives the ball, thereby saving vehicle weight, increasing the range of the vehicle and avoiding complexity. The drive motors, control sensors, and the control system employ components that are commercially available.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is perspective view of the balanced ball vehicle;

FIG. 2 is top view of the balanced ball vehicle of FIG. 1;

FIG. 3 is top view with the platform and battery removed showing reaction wheels and motor-driven wheels contacting the ball;

FIG. 4 is perspective view, similar to that of FIG. 1, illustrating the ball vehicle in an inclined disposition;

FIG. 5 is a schematic diagram of a system for controlling the vehicle;

FIG. 6 is a side view of portion of an alternate balance ball vehicle equipped with a handle bar;

FIG. 7 is a top perspective view of the vehicle of FIG. 6;

FIG. 8 is a top view of the vehicle of FIG. 6;

FIG. 9 is a side view of the vehicle of FIG. 6 showing in phantom lines a vehicle cover over the ball;

FIG. 10 is a perspective view showing the vehicle cover of FIG. 9;

FIG. 11 is a side view of the vehicle of FIG. 6 and the vehicle cover of FIG. 9; and

FIG. 12 is a schematic diagram of a system for controlling the vehicle of FIGS. 6-9.

### DESCRIPTION OF THE PREFERRED EMBODIMENT

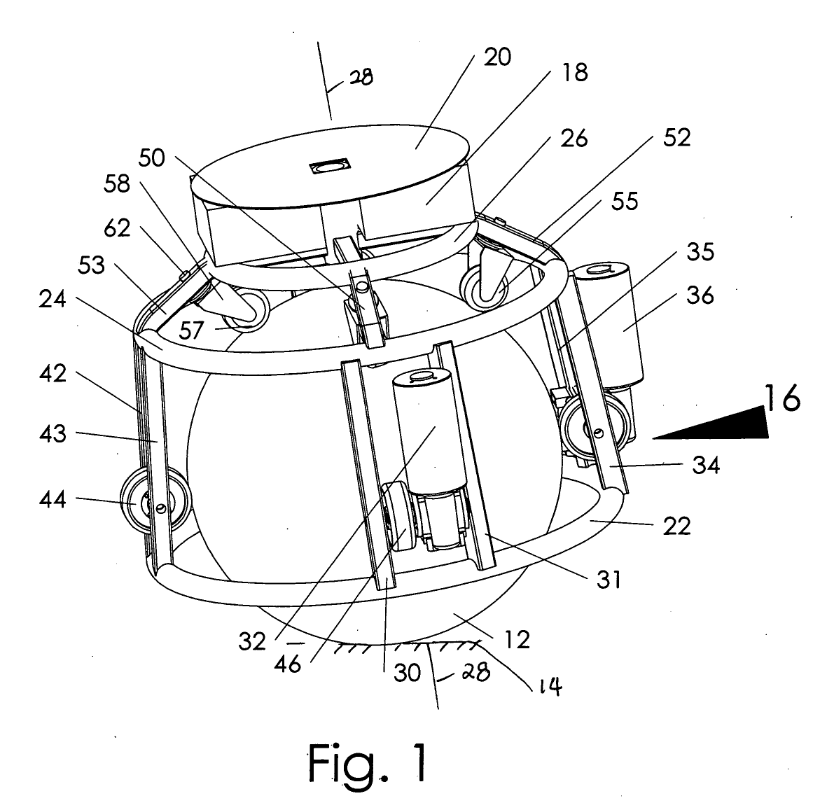

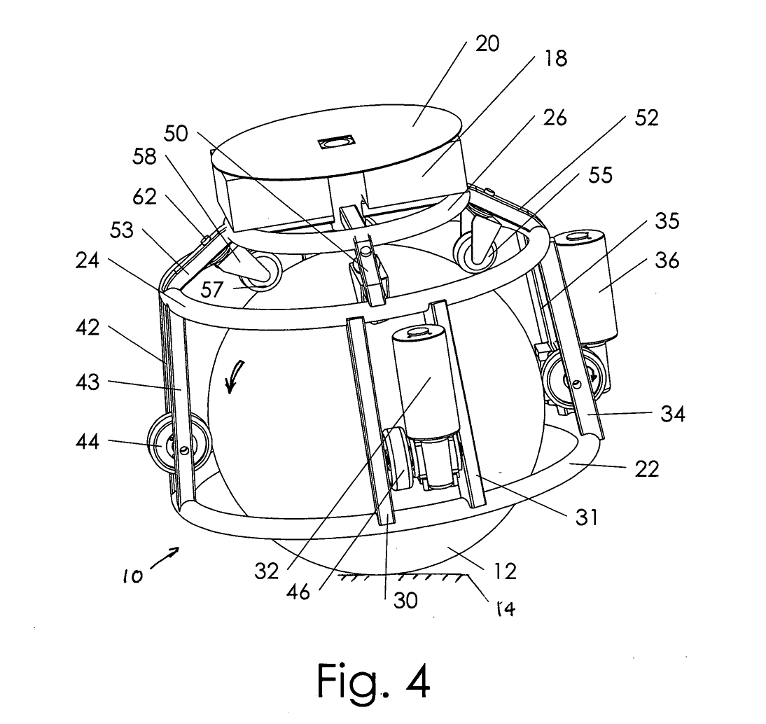

Referring to FIGS. 1-4, a vehicle 10 for transporting a person includes a spherical ball 12, preferably filled with pressurized gas such as air and supported on a contact surface 14, a frame 16 that surrounds the ball, a battery 18 mounted on an upper surface of the frame, and a platform 20, on which the vehicle's operator is seated above the battery. Frame 16 includes a lower circular rail 22, which encircles the ball, an intermediate circular rail 24, which encircles the ball at a higher elevation than rail 22, and an upper circular rail 26 located above rail 24 and supporting the battery 18.

Rails 22 and 24 are mutually interconnected by a series of posts, arranged in pairs angularly spaced about an axis 28. Posts 30, 31 of a first pair are secured to rails 22, 24, and post 31 supports an electric motor 32. Similarly, posts 34, 35 of a second pair are secured to rails 22, 24, and post 35 supports an electric motor 36. Posts 38, 39 are located diametrically opposite posts 30, 32, are secured to rails 22, 24, and support a wheel 40 for rotation about an axis that is substantially tangential to axis 28. Posts 42, 43 are located diametrically opposite posts 34, 35, are secured to rails 22, 24, and support a wheel 44 for rotation about an axis that is substantially tangential to axis 28.

Motor 32 drives wheel 46 in rotation about an axis that is substantially tangential to axis 28, and post 35 drives wheel 48 in rotation substantially tangential to axis 28. The driven wheels 46, 48 contact and are frictionally engaged with the ball 12. Preferably the points of contact between the ball 12 and wheels 40, 44, 46, 48 are located in a plane that passes through a diameter of the ball.

Wheels 40, 44 contact the ball but do not drive the ball in rotation. Wheel 40 provides at least a partial reaction to a radially directed force applied to the surface of the ball by driven wheel 36, and wheel 42 provides at least a partial reaction to a radially directed force applied to the surface of the ball by driven wheel 48.

Rails 24 and 26 are mutually interconnected by a series of posts 50-53, secured to rails 24, 26 and angularly spaced about axis 28. Post 50 supports a wheel 54 on a caster. Post 51 supports a wheel 55 on a caster. Post 52 supports a wheel 56 on a caster. Post 53 supports a wheel 57 on a caster. FIG. 1 shows the arrangement that is typical of wheels 50-53. Wheel 57 is pivotably supported on a caster 58 about a caster axis 60 at pin 62. Caster axis 60 passes through the center O of ball 12. In this way, the weight of the frame 16, components carried on the frame, battery 18, and the operator's weight on platform 20 is substantially directed by each caster wheel 50-53 radially to the center O.

In operation, the vehicle's operator, located on platform 20, indicates to a vehicle control system a desired direction of travel by changing the positioning of his center of gravity such that the center of gravity of the vehicle 10 and operator tilt the frame in the desired direction. The vehicle 10 then becomes unbalanced and begins to rotate toward the desired direction. The driving wheels 46, 48 rotate in response to torque produced by motors 32, 36, respectively, thereby rotating the ball 12 in the desired direction and keeping the ball supported on surface 14 under the center of gravity of the vehicle.

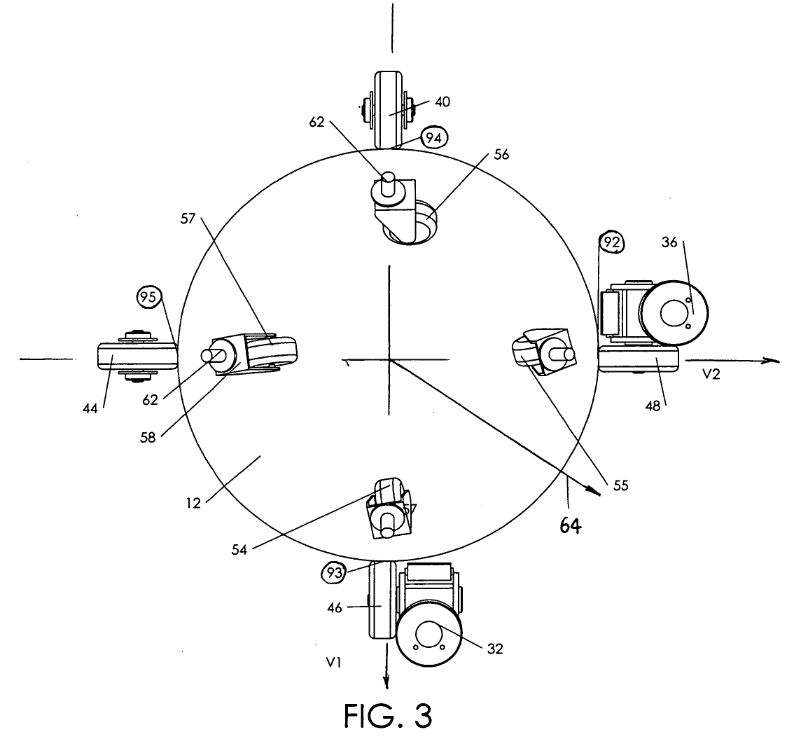

The driving wheels 46, 48 and at least one of the reaction wheels 40, 44, which are angularly spaced about axis 28 from the two driving wheels, contact the ball 12 in a plane through the diameter of the ball. As FIG. 3 illustrates, the resultant torque 64 about the center O due to frictional forces applied to the surface of the ball by the driving wheels cause the ball to roll in the direction of the vector 64. For example, if wheel 48 applies a downward frictional force on the ball, the corresponding torque about center O causes the ball to roll in direction V2. If wheel 46 applies a downward frictional force on the ball, the corresponding torque about center O causes the ball to roll in the direction V2. The wheels 46 and 48 are driven in this direction concurrently, the ball rolls in the resultant direction.

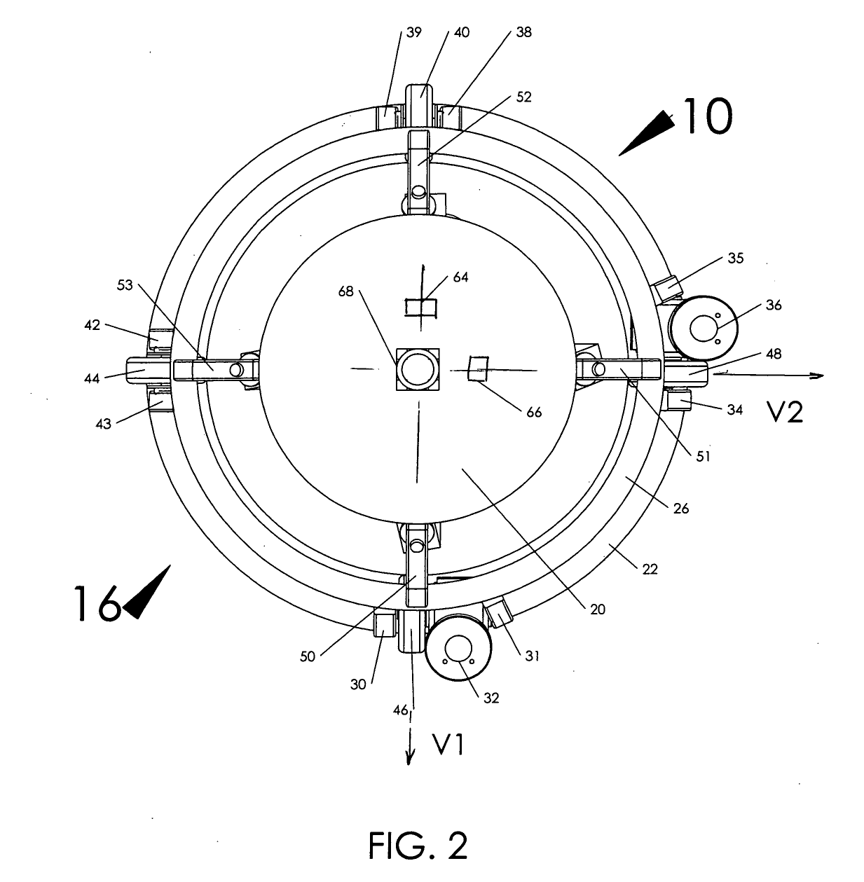

As FIG. 2 illustrates, preferably located on platform 20 are a sensor 64 that produces an electronic signal representing the angular displacement or tilt of the vehicle about the axis V1, and a sensor 66 that produces an electronic signal representing the angular displacement or tilt of the vehicle about the axis V2, and encoders 68 that produce electronic signals representing linear displacement along the V1 and V2 axes from a reference position, from which signals the position of the base of the vehicle is determined.

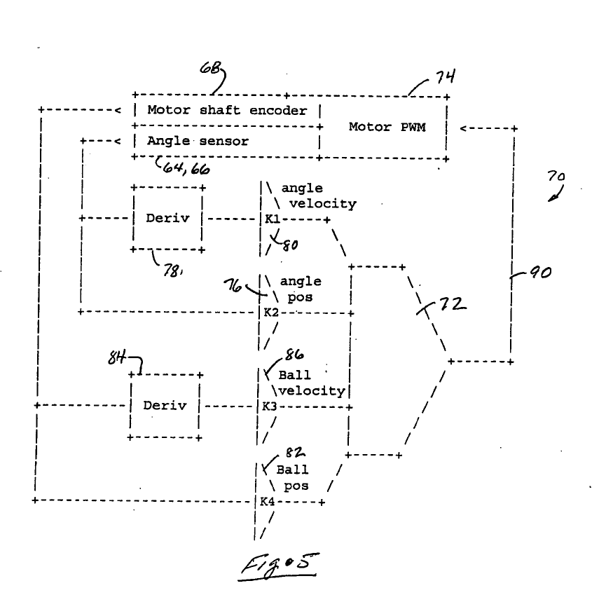

FIG. 5 illustrates schematically a system 70 for controlling the stability and movement of the vehicle 10 by controlling operation of the drive motors 32, 36. The control system 70 repetitively issues commands to the drive motors 32, 36, which respond to the commands by changing individually the rotating speed and torque of the motors such that the vehicle 10 remains balanced and moves in the desired direction. System 70 includes a fault controller 72, which detects a fault condition associated with the motor drive. Upon detection of the fault condition, the controller 72 adjusts the torque commanded by a motor drive 74, which produces a pulse width modulated command signal to the drive motors 32, 36.

The signals produced by sensors 64, 66 representing the tilt angles about axes V1 and V2 are sampled repetitively and supplied as input to the controller 72 at 76. Signal 66, 68 are differentiated repetitively with respect to time over the sampling intervals at 78, thereby producing at 80 the angular velocity of the ball 12 about axes V1 and V2. The signals from motor shaft encoders 68 are sampled repetitively and supplied as input to the controller 72 at 82, from which controller 72 determines the ball position about axes V1 and V2. Signal 68 are also differentiated repetitively with respect to time over the sampling intervals at 84, thereby producing at 86 the velocity of the ball 12 about axes V1 and V2.

These eight values are processed by controller 72, which repetitive executes algorithms using the input values and produces from the algorithms output commands 90, which are fed back to the drive motor 32, 36, preferably as PWM voltage signals. The algorithms use two input values about each of planes V1 and V2, and calculates the torque for the corresponding drive motor 32, 36 needed to stabilize the angular attitude of the vehicle and move the vehicle in the desired direction. The drive motors 32, 36 respond to the commands 90 by changing the motor torque produced by the motor, which torque is proportional to the duty cycle of the PWM signals. The drive wheels 46, 48 apply torque to the ball 12 keeping it balanced about planes V1, V2, and driving the vehicle 10 in the desired direction. The control executes the algorithms repeatedly about 80 times per second, sampling the ball position and tilt angle and updating the motor voltage to achieve vehicle balance. The constant for the ball location, K3, is set equal to 0 for the vehicle to travel, and to non-zero for the vehicle to hold its location. Steering is accomplished by tilting the vehicle.

FIG. 3 shows the driving wheels 46, 48 contacting the surface of ball 12 at points of contact 92, 93, and the reaction wheels 40, 44 contacting the surface of ball at points of contact 94, 95. Contact points 92-95 are in a diametric plane that passes through the center O of the ball 12.

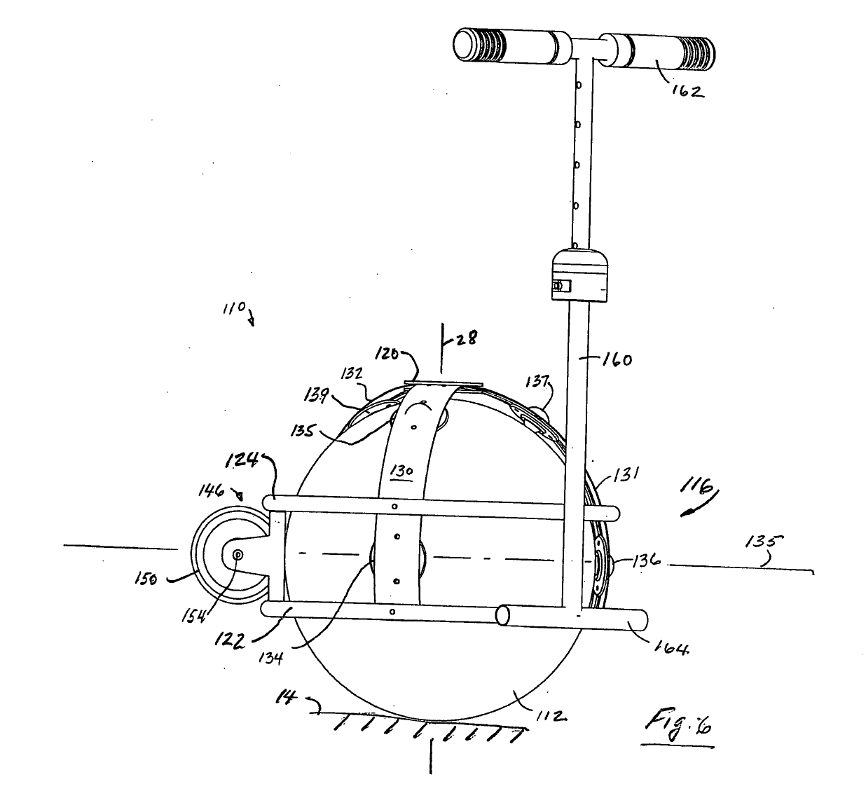

Referring to FIGS. 6-9, an alternate vehicle 100 for transporting a person on a spherical ball 12 on a contact surface 14, includes a frame 116 surrounding the ball, a battery 118 mounted on an upper surface of the frame, and a platform 120, on which the vehicle's operator is supported above the battery. Frame 116 includes a lower circular rail 122, which encircles the ball, and an upper circular rail 124, which encircles the ball at a higher elevation than rail 122.

Rails 122 and 124 are mutually interconnected by three bands or straps 130, 131, 132, angularly spaced about the axis 28 and secured to the platform 120. Band 130 carries spherical bearings 134, 135, which contact the surface of the ball 12 and support band 130. The lower bearing 134 contacts the ball 12 at a diametric, substantially horizontal plane 135 through the ball. Similarly, band 131 carries spherical bearings 136, 137, which contact the surface of the ball 12 and support band 131, the lower bearing 136 contacting the ball at diametric plane 135, where bearing 134 contacts the ball. Band 132 carries spherical bearings 138, 139, which contact the surface of the ball 12 and support band 132, the lower bearing 138 contacting the ball at diametric plane 135, where bearings 134, 136 contact the ball.

A pair of brackets 146, 148, mutually angularly spaced about axis 28, is secured to rails 122 and 124, each bracket supporting a drive motor 150, 152. The housing of drive motor 150 rotates about a tangential axis 154 and driveably engages the outer surface of the ball 12 at the diametric plane 135. Bearings 134, 136 and 138 also contact the ball 12 in plane 135. Similarly, the housing of drive motor 152 rotates about a tangential axis 156, which is perpendicular to axis 154, and driveably engages the outer surface of the ball 12 at the diametric plane 135. Bearings 134, 136 and 138 contact the ball 12 in plane 135.

Rails 122, 124 support a vertical post 160, which is secured to the posts and carries at its upper end a handle bar 162, which the vehicle operator grips manually. The length of post 160 is adjustable. Post 160 supports a horizontal lower bar 164, a fool rest for supporting the vehicle operator's feet above the surface 14 on which the ball is supported.

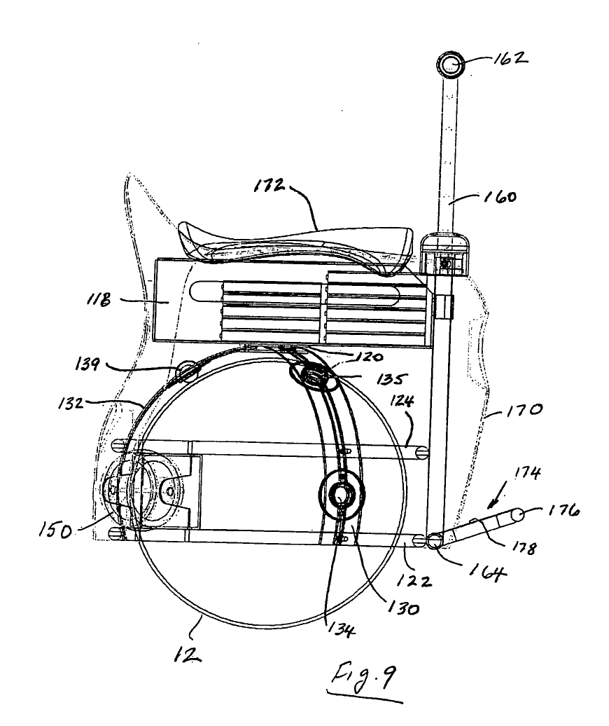

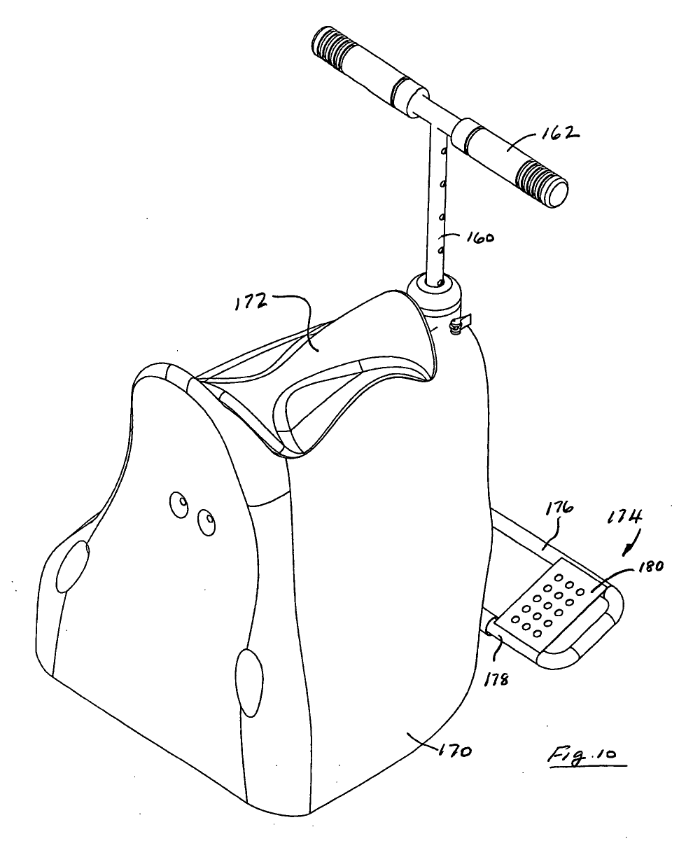

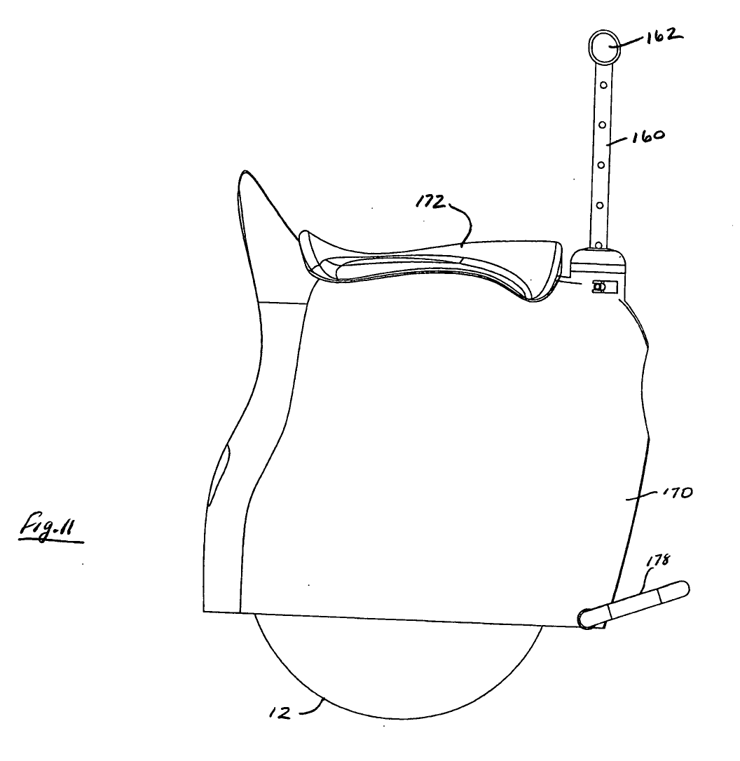

FIGS. 9-11 illustrates a vehicle cover 170, formed with a seat 172 for the vehicle operator, the cover contacting the battery 118, which is supported on the platform 120, bands 130-132, and ball 12. A foot rest 174 includes two horizontal bars 176, 178 extending in opposite direction from post 160 and supporting a plate 180 near each lateral end of the bars 176, 178.

In operation, the vehicle operator indicates to a vehicle control system a desired direction of travel by changing the positioning of his center of gravity such that the center of gravity of the vehicle 110 and operator tilt the frame 116 in the desired direction. The vehicle 110 then becomes unbalanced and begins to rotate toward the desired direction. The driving motors 150, 152 rotate in response to torque command signals, thereby rotating the ball 12 in the desired direction and keeping the ball supported on surface 14 under the center of gravity of the vehicle.

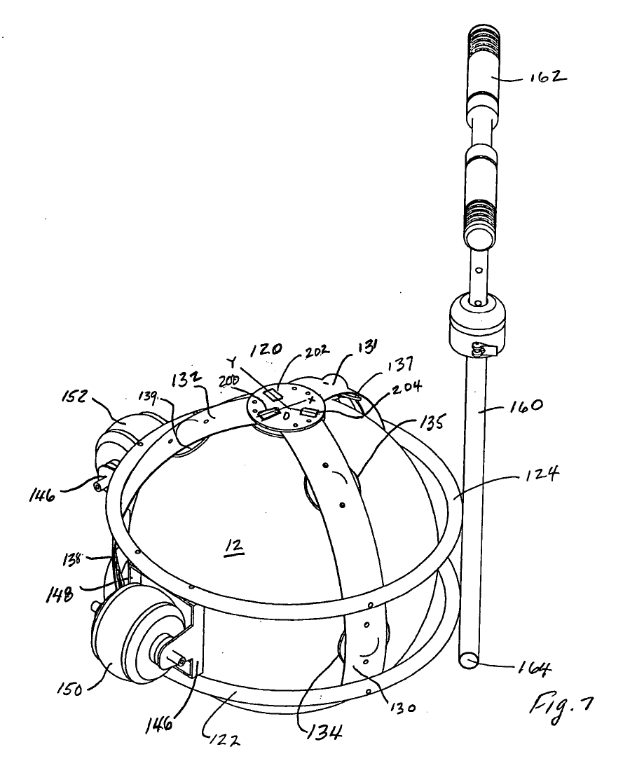

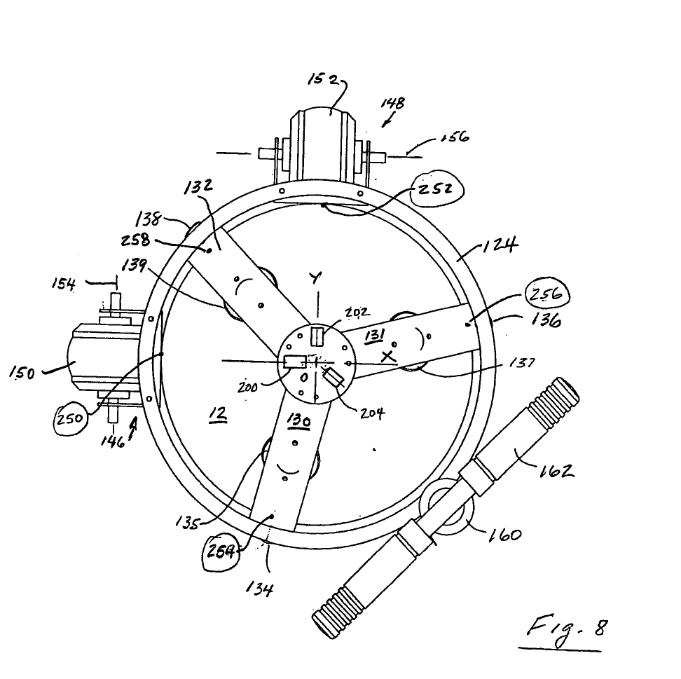

The resultant torque about the ball center O due to frictional forces applied to the surface of the ball by the driving motor wheels 150, 152 cause the ball to roll in the desired direction. As FIGS. 7 and 8 illustrate, preferably located on platform 120 are a sensor 200 such as a gyro, which produces an electronic signal representing the linear displacement of the vehicle along the X-axis from a reference position, a sensor 202 such as a gyro, which produces an electronic signal representing the linear displacement of the vehicle along the Y-axis from a reference position, and an inclinometer 204, which produces an electronic signal representing the angular displacement or tilt of the vehicle in the X axis, and an inclinometer 206, which produces an electronic signal representing the angular displacement or tilt of the vehicle in the y axis.

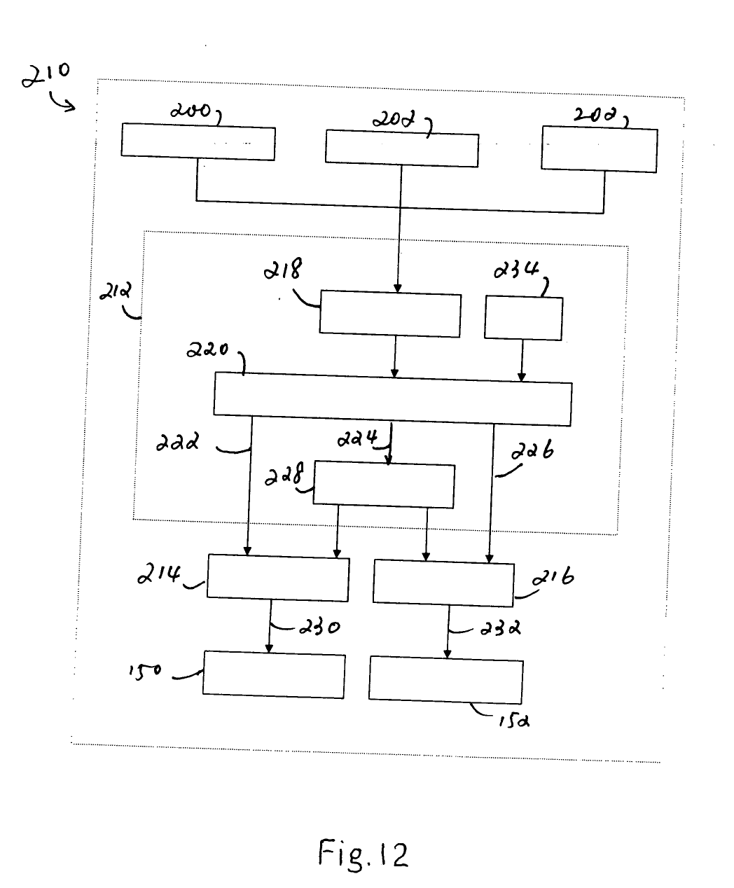

FIG. 12 illustrates schematically a system 210 for controlling the stability and movement of the vehicle 110 by controlling operation of the drive motors 150, 152. The control system 210 repetitively issues commands to the drive motors 150, 152, which respond to the commands by changing individually the rotating speed and torque of the motors such that the vehicle 110 remains balanced and moves in the desired direction. System 210 includes a controller 212, which detects a fault condition associated with the motor drive. Upon detection of the fault condition, the controller 212 adjusts the torque commanded by the X-axis motor drive 214 and Y-axis motor drive 216. Each motor drive 214, 216 produces a command signal to its respective drive motor 150, 152.

The signals produced by sensors 200, 202, 204, 206 are sampled repetitively and supplied as input to the controller 210 through an A/D converter 218, which converts the analog signal produced by the sensors to a digital signal. Signals 200, 202, 204, 206 are differentiated repetitively with respect to time over the sampling intervals by a microprocessor 220, producing the angular velocity of the vehicle frame 116 as it tilts about axes X and Y and its angular displacement between plane 135 and the X-Y plane.

Gyroscope 200 detects the angular velocity of the frame tilting about the X-axis, and inclinometer 204 detects the tilting angle of the frame about the X-axis relative to the horizontal plane 135. Motor 150 responds to command signals issued by controller 210 to change the rotation velocity of the ball 12 about the X-axis. Gyroscope 202 detects the angular velocity of the frame tilting about the Y-axis, and inclinometer 206 detects the tilting angle of the frame about the Y-axis relative to the horizontal plane 135. Motor 152 responds to command signals from controller 210 to change the rotation velocity of the ball about the Y-axes.

The controller 212 repetitive executes algorithms using the input values and produces from the algorithms output command signals 222, 224, 226, which are sent directly to the motor controls 214, 216, or processed through a D/A converter 228.

The algorithms use input values about each of planes X and Y, and calculate the torque for the corresponding drive motor 150, 152 needed to stabilize the angular attitude of the vehicle and move the vehicle in the desired direction. The drive motors 150, 152 respond to command signals 230, 232 produced by the motor controls 214, 216, respectively, by changing the motor torque produced by the motor, which torque is proportional to the duty cycle of the PWM control signals 230, 232. The drive motors wheels 150, 152 apply torque to the ball 12 keeping it balanced about the X and Y planes and driving the vehicle 110 in the desired direction.

The control 210 system executes the algorithms repeatedly about 25 times per second, sampling the ball position and tilt angle and updating the motor voltage to achieve vehicle balance. Steering is accomplished by tilting the vehicle to the side.

FIG. 8 shows the driving wheels 150, 152 contacting the surface of ball 12 at points of contact 250, 252, and the spherical bearings 134, 136, 138 contacting the surface of the ball at points of contact 254, 256, and 258. Contact points 250, 252, 254, 256, 258 are in a diametric plane that passes through the center O of the ball 12.

A switch 234 accessible to the vehicle operator reboots the microprocessor 220.

In accordance with the provisions of the patent statutes, the preferred embodiment has been described. However, it should be noted that the alternate embodiments can be practiced otherwise than as specifically illustrated and described.

What is claimed is:

1. A balancing ball vehicle comprising:
a spherical ball having a center and a central axis that passes through the center;
a first driving wheel frictionally engaged with the ball and rotating about a first wheel axis; and
a second driving wheel angularly spaced about the central axis from the first driving wheel, frictionally engaged with the ball, and rotating about a second wheel axis.

2. The vehicle of claim 1, wherein the first wheel axis and second wheel axis are in a plane that contains and passes through the center of the ball.

3. The vehicle of claim 1, wherein:
the first driving wheel contacts the ball at a first point of contact, the center and first point of contact defining a line; and the second driving wheel contacts the ball at a second point of contact that is not located on the line.

4. The vehicle of claim 1, wherein:
the first driving wheel contacts the ball at a first point of contact;
the second driving wheel contacts the ball at a second point of contact; and
further comprising a first reaction wheel that contacts the ball at a third point of contact and rotates about a third wheel axis, the first wheel axis, second wheel axis and third wheel axis being in a plane that contains and passes through the center of the ball.

5. The vehicle of claim 1, further comprising:
multiple castered wheels contacting the ball and supporting the platform on the ball, each castered wheel supported on a caster axis that passes through the center of the ball.

6. The vehicle of claim 1, further comprising:
a first reaction wheel contacting the ball diametrically opposite the first driven wheel; and
a second reaction wheel contacting the ball diametrically opposite the second driven wheel.

7. The vehicle of claim 1, further comprising:
a first electric motor for driving the first wheel;
a second electric motor for driving the second wheel;
multiple sensors producing signals representing angular velocity of the frame about a first reference axis of the ball, displacement of the vehicle along a first reference axis, a second sensor producing a signal representing angular velocity of the frame tilting about the second reference axis of the ball, displacement of the vehicle along a second reference axis, and a third sensor producing a signal representing an angular disposition of the vehicle with respect to a horizontal plane; and
a system for driving the vehicle in a desired direction and controlling stability of the vehicle including a controller configured to communicating with signals produced by the sensors, and to execute control algorithms that use information represented by said signals and produce output command signals; and
a motor drive responsive to the command signals for driving the first and second motors.

8. The vehicle of claim 1, further comprising:
a platform;
a battery pack supported on the ball;
a first electric motor for driving the first wheel;
a second electric motor for driving the second wheel;
a frame supported on the ball and carrying the platform, the first driving wheel, the second driving wheel, the first electric motor and the second electric motor.

9. The vehicle of claim 8, further comprising:
a cover at least partially covering the ball and frame, and supported on the platform;
a seat supported on the frame;
a foot rest supported on the frame; and
a handle bar supported on the frame.

10. A balancing ball vehicle comprising:
a spherical ball having a center and a central axis that passes through the center;
a first driving motor frictionally engaged with the ball and supported for rotation perpendicular to a first radius of the ball;
a second driving motor angularly spaced about the central axis from the first driving wheel, frictionally engaged with the ball, and supported for rotation about perpendicular to a second radius of the ball;
multiple first bearings mutually angularly spaced about the central axis, each first bearing contacting the ball at first points of contact that define a first plane; and
multiple second bearings mutually angularly spaced about the central axis, each multiple second bearings first bearing contacting the ball at second points of contact that define a second plane that passes through the center.

11. The vehicle of claim 10, wherein the second radius is perpendicular to the first radius.

12. The vehicle of claim 10, wherein:
the first driving motor contacts the ball at a third point of contact, the center and third point of contact defining a line; and
the second driving motor contacts the ball at a fourth point of contact that is not located on the line.

13. The vehicle of claim 10, wherein:
the first driving motor contacts the ball at a third point of contact located on the second plane;
the second driving motor contacts the ball at a fourth point of contact located on the second plane.

14. The vehicle of claim 10, further comprising:
multiple sensors producing signals representing angular velocity of the frame about a first reference axis of the ball, displacement of the vehicle along a first reference axis, a second sensor producing a signal representing angular velocity of the frame tilting about the second reference axis of the ball, displacement of the vehicle along a second reference axis, and a third sensor producing a signal representing an angular disposition of the vehicle with respect to a horizontal plane; and
a system for driving the vehicle in a desired direction and controlling stability of the vehicle including a controller configured to communicating with signals produced by the sensors, and to execute control algorithms that use information represented by said signals and produce output command signals; and
a motor drive responsive to the command signals for driving the first and second motors.

15. The vehicle of claim 10, further comprising:
a battery pack supported on the ball;
a first electric motor for driving the first wheel;
a second electric motor for driving the second wheel;
a frame supported on the ball and carrying the platform, the first driving wheel, the second driving wheel, the first electric motor and the second electric motor.

16. The vehicle of claim 15, further comprising:
a cover at least partially covering the ball and frame, and supported on the platform;
a seat supported on the frame;
a foot rest supported on the frame; and
a handle bar supported on the frame.

17. A balancing ball vehicle comprising:
a spherical ball having a center and a central axis that passes through the center;
a first driving motor frictionally engaged with the ball at a first point of contact, and supported for rotation perpendicular to a first radius of the ball;
a second driving motor angularly spaced about the central axis from the first driving motor, frictionally engaged with the ball at a first point of contact, and supported for rotation perpendicular to a second radius of the ball perpendicular to the first radius, the first electric motor driving the ball about the second radius, the second electric motor driving the ball about the first radius;
multiple first bearings, each first bearing mutually angularly spaced about the central axis, located above the elevation of the center, and contacting the ball at third points of contact that define a first plane; and
multiple second bearings, each second bearing mutually angularly spaced about the central axis, contacting the ball at fourth points of contact that define a second plane that passes through the center.

18. The vehicle of claim 17, wherein:
the first point of contact and the second point of contact being located in the second plane.

19. The vehicle of claim 17, further comprising:
a frame supported on the ball;
bands secured to the frame and supported on the ball at the first bearings; and
a platform for supporting a vehicle operator thereon and secured bands.

20. The vehicle of claim 17, further comprising:
multiple sensors producing signals representing angular velocity of the frame about a first reference axis of the ball, displacement of the vehicle along a first reference axis, a second sensor producing a signal representing angular velocity of the frame tilting about the second reference axis of the ball, displacement of the vehicle along a second reference axis, and a third sensor producing a signal representing an angular disposition of the vehicle with respect to a horizontal plane; and
a system for driving the vehicle in a desired direction and controlling stability of the vehicle including a controller configured to communicating with signals produced by the sensors, and to execute control algorithms that use information represented by said signals and produce output command signals; and
a motor drive responsive to the command signals for driving the first and second motors.
